(19) United States
(12) Patent Application Publication
(10) Pub. No.: US 2015/0086749 A1
(43) Pub. Date: Mar. 26, 2015

(54) RELEASE FILM FOR PRODUCING GREEN SHEET

(71) Applicant: LINTEC CORPORATION, Tokyo (JP)

(72) Inventors: Tomomi Fukaya, Tokyo (JP); Shinya Ichikawa, Tokyo (JP)

(21) Appl. No.: 14/394,587

(22) PCT Filed: Mar. 14, 2013
(86) PCT No.: PCT/JP2013/057185

§ 371 Date: Oct. 16, 2014

(30) Foreign Application Priority Data
Apr. 23, 2012 (JP) 2012-098140

(51) Int. Cl. C09D 135/02

(52) U.S. Cl. CPC C09D 135/02
USPC 428/141

(57) ABSTRACT

A release film for producing a green sheet of the present invention includes a base material having a first surface and a second surface, a release agent layer formed by applying a material containing an active energy ray curable compound (a1) and a polyorganosiloxane (b1) onto a side of the first surface of the base material and curing the material, and a back coat layer formed by applying a material containing an active energy ray curable compound (a2) onto a side of the second surface of the base material and curing the material. An arithmetic average roughness Ra₂ of an outer surface of the release agent layer is 8 nm or less and a maximum projection height Rp₂ of the outer surface is 50 nm or lower. An arithmetic average roughness Ra₃ of an outer surface of the back coat layer is in the range of 5 to 40 nm and a maximum projection height Rp₃ of the outer surface of the back coat layer is in the range of 60 to 500 nm. According to the present invention, it is possible to prevent pinholes and variation in partial thickness from occurring to the green sheet.

### TECHNICAL FIELD

The present invention relates to a release film for producing a green sheet.

### RELATED ART

When manufacturing a multilayer ceramic capacitor, a release film for producing a green sheet is used to form the green sheet.

The release film for producing the green sheet is usually composed of a base material and a release agent layer. The green sheet is manufactured by coating a ceramic slurry, in which ceramic particles and a binder resin are dispersed and dissolved in an organic solvent, on the release film for producing the green sheet and drying the coated ceramic slurry. By this method, it is possible to efficiently manufacture the green sheet having a uniform thickness. The green sheet thus manufactured is released from the release film for producing the green sheet and is used in manufacturing the multilayer ceramic capacitor.

During the manufacture of the green sheet as described above, the release film for producing the green sheet on which the green sheet is formed is usually stored and transported in a rolled state.

In the prior art, there has been made an attempt by which, a surface roughness (average roughness) of a surface (rear surface) of the base material opposite to a surface on which the release agent layer is formed is kept relatively high to prevent a problem of sticking (blocking) of front and rear surfaces of the release film for producing the green sheet stored in the rolled state (see, e.g., Patent Document 1).

However, in case of using the release film for producing the green sheet disclosed in Patent Document 1, it is sometimes a case that, when the release film for producing the green sheet provided with the green sheet is stored in the rolled state, a relatively rough surface shape of the rear surface of the release film for producing the green sheet is transferred to the green sheet and therefore the green sheet is partially made thin. As a result, when the capacitor is manufactured by laminating the green sheet, there may be a case where a defect is generated by short circuit.

On the other hand, if the surface roughness of the surface of the base material opposite to the surface on which the release agent layer is formed is made relatively low, the surface becomes too smooth and a sliding property of each front and rear surface of the release film for producing the green sheet grows poor. For that reason, there may be a case where a defect such as poor winding or blocking occurs.

The Patent Document 1 is JP-A 2003-203822.

### SUMMARY OF THE INVENTION

It is an object of the present invention to provide a release film for producing a green sheet that is capable of preventing generation of a pinhole, a partial thickness variation and the like in the green sheet.

The above object is achieved by the inventions (1) and (2) set forth below.

(1) A release film for producing a green sheet, comprising:
a base material having a first surface and a second surface;
a release agent layer provided at a side of the first surface of the base material, wherein the release agent layer is formed by irradiating an active energy ray to a coated layer and curing the coated layer, wherein the coated layer is formed by coating a release-agent-layer-forming material on the side of the first surface of the base material, and wherein the release-agent-layer-forming material includes an active energy ray curable compound (a1) and a polyorganosiloxane (b1); and
a back coat layer provided at a side of the second surface of the base material, wherein the back coat layer is formed by irradiating the active energy ray to a coated layer and curing the coated layer, wherein the coated layer is formed by coating a back-coat-layer-forming material on the side of the second surface of the base material, and wherein the back-coat-layer-forming material includes an active energy ray curable compound (a2),
wherein an arithmetic average roughness Ra₂ of an outer surface of the release agent layer is 8 nm or less and a maximum projection height Rp₂ of the outer surface of the release agent layer is 50 nm or less, and
wherein an arithmetic average roughness Ra₃ of an outer surface of the back coat layer is in the range of 5 to 40 nm and a maximum projection height Rp₃ of the outer surface of the back coat layer is in the range of 60 to 500 nm.

(2) In the release film for producing the green sheet described in the above-mentioned invention (1), the back-coat-layer-forming material further includes a polyorganosiloxane (b2).

According to the present invention, it becomes possible to prevent the generation of the pinhole or the partial thickness variation in the green sheet. Further, the release film for producing the green sheet is capable of obtaining high smoothness of the outer surface of the release agent layer and is capable of providing with superior releasability.

### BRIEF DESCRIPTION OF THE DRAWINGS

FIG. 1 is a cross sectional view of a release film for producing a green sheet according to the present invention.

### DETAILED DESCRIPTION OF THE PREFERRED EMBODIMENTS

Hereinafter, the present invention will be described in detail based on a preferred embodiment.

(Release Film for Producing Green Sheet)

A release film for producing a green sheet according to the present invention is used in manufacturing a green sheet.

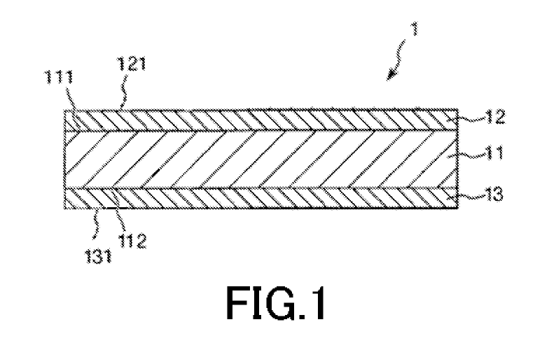

FIG. 1 is a cross sectional view of a release film 1 for producing a green sheet according to the present invention.

As shown in FIG. 1, the release film 1 for producing the green sheet includes a base material 11, a release agent layer 12 formed on a first surface 111 of the base material 11 and a back coat layer 13 formed on a second surface 112 of the base material 11.

The release film for producing the green sheet according to the present invention is characterized by including the base material having the first surface and the second surface; the release agent layer provided at the side of the first surface of the base material, wherein the release agent layer is formed by irradiating an active energy ray to a coated layer and curing the coated layer, wherein the coated layer is formed by coating a release-agent-layer-forming material on the side of the first surface of the base material, and wherein the release-agent-layer-forming material includes an active energy ray curable compound (a1) and a polyorganosiloxane (b1); and the back coat layer provided at the side of the second surface of the base material, wherein the back coat layer is formed by irradiating the active energy ray to a coated layer and curing the coated layer, wherein the coated layer is formed by coating a back-coat-layer-forming material on the side of the second surface of the base material, and wherein the back-coat-layer-forming material includes an active energy ray curable compound (a2), wherein an arithmetic average roughness Ra₂ of an outer surface of the release agent layer is 8 nm or less and a maximum projection height Rp₂ of the outer surface of the release agent layer is 50 nm or less, and wherein an arithmetic average roughness Ra₃ of an outer surface of the back coat layer is in the range of 5 to 40 nm and a maximum projection height Rp₃ of the outer surface of the back coat layer is in the range of 60 to 500 nm.

By setting the outer surface of the release agent layer to be smoother than the outer surface of the back coat layer in this way, it is possible to prevent the pinhole from being formed in the green sheet by generating a region where a depression (depressed part) of the green sheet which may be formed by projections of the outer surface of the release agent layer coincides with a depression (depressed part) of the green sheet which may be formed by projections of the outer surface of the back coat layer.

By using the release film for producing the green sheet having the aforementioned features according to the present invention, a relatively rough surface shape of the base material is not transferred to the green sheet because the base material is not in contact with the green sheet directly. As a result, it is possible to prevent the generation of the pinhole, the partial thickness variation and the like in the green sheet, thereby enabling a high-quality green sheet to form. In particular, even if the green sheet has an extremely small thickness (e.g., a thickness of 5 μm or less, particularly a thickness of from 0.5 μm to 2 μm), it is possible to form the high-quality green sheet which is free from the aforementioned defects.

Furthermore, the release film for producing the green sheet according to the present invention as described above includes the outer surface having high smoothness of the release agent layer and provides with the superior releasability. For this reasons, it is possible to form the high-quality green sheet.

Furthermore, by using the aforementioned materials to the release agent layer and the back coat layer, the release agent layer and the back coat layer have electric characteristics similar to each other. Thus, it is possible to prevent a generation of static electricity at unwinding the release film for producing the green sheet. As a result, it is possible to prevent generations of repellence of the slurry, the pinhole and the like at the time of coating the ceramic slurry, which is caused by allowing a foreign substance such as dust or rubbish to adhere to the release film for producing the green sheet due to the generated static electricity.

Detailed description will now be made on respective layers that constitute the release film 1 for producing the green sheet according to the present embodiment.

<Base Material>

The base material 11 includes the first surface 111 and the second surface 112.

The base material 11 serves to apply physical strength, such as rigidity or flexibility, to the release film 1 for producing the green sheet.

The base material 11 is not particularly limited. An arbitrary one of the materials well-known in the art can be suitably selected and used as the base material 11. Examples of the base material 11 may include a film made of a plastic, e.g., polyester such as polyethyleneterephthalate or polyethylenenaphthalate, polyolefin such as polypropylene or polymethylpentene, or polycarbonate. The base material 11 may be a monolayer or may be multiple layers including two or more layers of the same kind or different kinds. Among them, a polyester film is preferred. A polyethyleneterephthalate film is particularly preferred. A biaxially-stretched polyethyleneterephthalate film is more preferred. The film made of the plastic seldom generates dust or the like during the processing, use thereof or the like. It is therefore possible to effectively prevent a generation of a coating defect of the ceramic slurry by the dust or the like.

An arithmetic average roughness Ra₁ of the first surface 111 of the base material 11 is preferably in the range of 2 to 80 nm and more preferably in the range of 5 to 50 nm. As will be described later, a smoothened release agent layer 12 that fills spaces of depressed parts and slant surfaces of raised parts of the first surface 111 of the base material 11 is formed on the first surface 111 of the base material 11. Therefore, if the arithmetic average roughness Ra₁ is set to fall within the above range, a smoothening action becomes particularly remarkable.

A maximum projection height Rp₁ of the first surface 111 of the base material 11 is preferably in the range of 10 to 700 nm and more preferably in the range of 20 to 500 nm. As will be described later, the smoothened release agent layer 12 that fills the spaces of the depressed parts and the slant surfaces of the raised parts of the first surface 111 of the base material 11 is formed on the first surface 111 of the base material 11. Therefore, if the maximum projection height Rp₁ is set to fall within the above range, the smoothening action becomes particularly remarkable.

An arithmetic average roughness Ra₀ of the second surface 112 of the base material 11 is preferably in the range of 10 to 200 nm and more preferably in the range of 15 to 100 nm. As will be described later, the back coat layer 13 is formed on the second surface 112 of the base material 11. Therefore, if the arithmetic average roughness Ra₀ is set to fall within the above range, it is easy to adjust the arithmetic average roughness Ra₃ of an outer surface 131 of the back coat layer 13.

A maximum projection height Rp₀ of the second surface 112 of the base material 11 is preferably in the range of 80 to 1000 nm and more preferably in the range of 100 to 800 nm. As will be described later, the back coat layer 13 is formed on the second surface 112 of the base material 11. Therefore, if the maximum projection height Rp₀ is set to fall within the above range, it is easy to adjust the maximum projection height Rp₃ of the outer surface 131 of the back coat layer 13.

An average thickness of the base material 11 is preferably in the range of 10 to 300 μm and more preferably in the range of 15 to 200 μm. In this case, resistance against tear or breaking of the release film 1 for producing the green sheet can be made particularly superior while keeping the proper flexibility of the release film 1 for producing the green sheet.

<Release Agent Layer>

The release agent layer 12 is formed on the first surface 111 of the base material 11.

The release agent layer 12 serves to apply the releasability to the release film 1 for producing the green sheet.

The release agent layer 12 is a layer which is formed by irradiating an active energy ray to the release-agent-layer-forming material containing the specified components, and by curing the release-agent-layer-forming material.

The release-agent-layer-forming material contains the active energy ray curable compound (a1) and the polyorganosiloxane (b1).

Use of this release-agent-layer-forming material makes it possible to keep particularly superior curability of the release agent layer 12 at the forming itself and the releasability against the green sheet.

The respective components of the release-agent-layer-forming material will now be described in detail.

[Active Energy Ray Curable Compound (a1)]

The active energy ray curable compound (a1) is a component that makes contribution to the formation of the release agent layer 12 by curing.

It is preferred that the active energy ray curable compound (a1) has, in one molecule, two or more (preferably three or more) reactive functional groups selected from a (meth)acryloyl group, an alkenyl group and a maleimide group. Thus, it is possible to obtain the superior curability, superior solvent resistance and the superior releasability. Examples of the alkenyl group may include a group having a carbon number of 2 to 10 such as a vinyl group, an allyl group, a propenyl group and a hexenyl group.

In the active energy ray curable compound (a1), a content of the reactive functional groups selected from the (meth)acryloyl group, the alkenyl group and the maleimide group is preferably an equivalent of 10 or more per 1 kg of the active energy ray curable compound (a1). In this case, even when the release-agent-layer-forming material is coated as a thin film on the first surface 111, it is possible to keep particularly the superior curability of the active energy ray curable compound (a1).

Specific examples of the active energy curable compound (a1) may include a multifunctional (meth)acrylate such as dipentaerythritol tri(meth)acrylate, dipentaerythritol tetra(meth)acrylate, dipentaerythritol penta(meth)acrylate, dipentaerythritol hexa(meth)acrylate, pentaerythritol tri(meth)acrylate and pentaerythritol tetra(meth)acrylate. Among them, it is preferable to use at least one multifunctional acrylate selected from the group consisting of dipentaerythritol triacrylate, dipentaerythritol tetraacrylate, dipentaerythritol pentaacrylate, dipentaerythritol hexaacrylate, pentaerythritol triacrylate, and pentaerythritol tetraacrylate. In this case, even when the release-agent-layer-forming material is coated as the thin film on the first surface 111, it is possible to keep particularly the superior curability of the active energy ray curable compound (a1).

A solid component content (content ratio in the total solid components except a solvent) of the active energy ray curable compound (a1) in the release-agent-layer-forming material is preferably in the range of 65 to 98.5 mass % and more preferably in the range of 71 to 96.3 mass %.

Examples of active energy rays may include an electromagnetic wave such as infrared light, visible light, ultraviolet rays, and X-rays, and a particle beam such as an electron beam, an ion beam, neutron rays and alpha rays. Among them, the ultraviolet rays are preferred. This makes it possible to form the release agent layer 12 easily and reliably.

[Polyorganosiloxane (b1)]

The polyorganosiloxane (b1) is a component for developing the releasability in the release agent layer 12.

Examples of the polyorganosiloxane (b1) may include a polyorganosiloxane having a straight or branched molecular chain. Particularly, it is preferable to use a denatured polyorganosiloxane in which at least one reactive functional group selected from the group consisting of a (meth)acryloyl group, an alkenyl group and a maleimide group in terminals of the molecular chain or as a side chain of the molecular chain is bonded to silicon atoms of the molecular chain, either directly or through a bivalent linking group. Examples of the alkenyl group may include a group having a carbon number of 2 to 10 such as a vinyl group, an allyl group, a propenyl group and a hexenyl group. Examples of the bivalent linking group may include an alkylene group, an alkyleneoxy group, an oxy group, an imino group, a carbonyl group and the combinations thereof. The carbon number of the bivalent linking group is preferably in the range of 1 to 30 and more preferably in the range of 1 to 10. Depending on the necessity, the polyorganosiloxane (b1) may be used in combination of two or more kinds thereof.

The denatured polyorganosiloxane substituted by the reactive functional group is incorporated into and fixed to a cross-linking structure of a cured body of the active energy ray curable compound (a1) when the active energy ray curable compound (a1) is cured by the irradiation of the active energy rays. This makes it possible to prevent the polyorganosiloxane as one component of the release agent layer 12 from migrating to and transferring to the green sheet formed on an outer surface 121 of the release agent layer 12.

Examples of an organic group other than the reactive functional group that constitutes the polyorganosiloxane (b1) may include a monovalent hydrocarbon group that does not have an aliphatic unsaturated bond. The organic group may be a plurality of hydrocarbon groups in which the hydrocarbon groups may be the same kind or different kinds. The carbon number of the hydrocarbon group is preferably in the range of 1 to 12 and more preferably in the range of 1 to 10. Specific examples of the hydrocarbon group may include an alkyl group such as a methyl group, an ethyl group or a propyl group, and an aryl group such as a phenyl group or a tolyl group.

Particularly, it is preferred that 80 mol % or more of the organic group other than the reactive functional group that constitutes the polyorganosiloxane (b1) is the methyl group. In this case, the releasability of the release agent layer 12 can be kept particularly superior.

A solid component content of the polyorganosiloxane (b1) in the release-agent-layer-forming material is preferably in the range of 0.5 to 5 mass % and more preferably in the range of 0.7 to 4 mass %. In this case, the ceramic slurry can be coated on the base material 11 without being repelled. This makes it possible to keep particularly the superior releasability of the release film 1 for producing the green sheet.

In contrast, if the solid component content of the polyorganosiloxane (b1) in the release-agent-layer-forming material is less than the lower limit value, there is a fear that the release agent layer 12 thus formed cannot show the sufficient releasability. On the other hand, if the solid component content of the polyorganosiloxane (b1) in the release-agent-layer-forming material exceeds the upper limit value, there is a fear that, when the ceramic slurry is coated on the surface of the release agent layer 12, the ceramic slurry is repelled with ease. Furthermore, there is sometimes a case that the release agent layer 12 is hardly cured and the sufficient releasability is not obtained.

Assuming that a blending amount of the active energy ray curable compound (a1) is A mass parts and a blending amount of the polyorganosiloxane (b1) is B mass parts, a mass ratio B/A is preferably in the range of 0.7/99.3 to 5/95 and more preferably in the range of 1/99 to 4.5/95.5. In this case, the aforementioned effects become more remarkable.

[Photopolymerization Initiator (c1)]

In case where the ultraviolet rays are used as the active energy rays for curing the release-agent-layer-forming material, the release-agent-layer-forming material may include a photopolymerization initiator (c1).

The photopolymerization initiator (c1) is not particularly limited. For example, it is preferable to use an α-aminoalkylphenone-based photopolymerization initiator. Such an α-aminoalkylphenone-based photopolymerization initiator is a compound which makes the active energy ray curable compound (a1) be less susceptible to the oxygen inhibition at curing the active energy ray curable compound (a1). Thus, the superior curability can be obtained even if the release film 1 for producing the green sheet is manufactured under an air atmosphere.

Examples of the α-aminoalkylphenone-based photopolymerization initiator may include 2-methyl-1-[4-(methylthio)phenyl]-2-morpholinopropane-1-one, 2-benzyl-2-dimethylamino-1-(4-morpholinophenyl)-butanone-1,2-(dimethylamino)-2-[(4-methylphenyl)methyl]-1-[4-(4-morpholinyl)phenyl]-1-butanone and the like. In this case, it is possible to obtain the superior curability, the superior solvent resistance and the superior releasability.

A solid component content of the photopolymerization initiator (c1) in the release-agent-layer-forming material is preferably in the range of 1 to 20 mass % and more preferably in the range of 3 to 15 mass %. In this case, even if the release agent layer 12 has a thickness at which the curability is hardly obtainable due to the oxygen inhibition, it is possible to obtain the superior curability, the superior solvent resistance and the superior releasability.

In the release film 1 for producing the green sheet described above, a component deriving from the polyorganosiloxane (b1) is segregated near the outer surface 121 of the release agent layer 12. The reason for occurrence of this segregation is presumed to be that, due to the use of the polyorganosiloxane (b1) differing in a molecular structure, polarity, a molecular weight or the like from the active energy ray curable compound (a1), the polyorganosiloxane is pushed up toward the surface while the coated layer of the release-agent-layer-forming material is cured.

The release-agent-layer-forming material may contain other components in addition to the aforementioned components. For instance, the release-agent-layer-forming material may contain a sensitizer, an antistatic agent, a hardening agent, a reactive monomer, and so forth.

As the sensitizer, it may be possible to use, e.g., 2,4-diethyl thioxanthone or isopropyl thioxanthone. This makes it possible to enhance reactivity.

A solid component content of other components in the release-agent-layer-forming material is preferably in the range of 0 to 10 mass %.

The arithmetic average roughness Ra₂ of the outer surface 121 of the release agent layer 12 is 8 nm or less. Thus, when the green sheet is molded on the outer surface 121 of the release agent layer 12, it is possible to reliably prevent the generation of the pinhole, the partial thickness variation and the like in the green sheet. This makes it possible to keep highly smooth a surface of the green sheet.

The maximum projection height Rp₂ of the outer surface 121 of the release agent layer 12 is 50 nm or less. Thus, when the green sheet is molded on the outer surface 121 of the release agent layer 12, it is possible to reliably prevent the generation of the pinhole, the partial thickness variation or the like in the green sheet. This makes it possible to keep highly smooth the surface of the green sheet.

It is preferable that an area occupation ratio of projections having a height of 10 nm or higher in the outer surface 121 of the release agent layer 12 is 10% or less. Thus, when the green sheet is molded on the outer surface 121 of the release agent layer 12, it is possible to reliably prevent the generation of the pinhole, the partial thickness variation and the like in the green sheet. This makes it possible to keep highly smooth the surface of the green sheet.

An average thickness of the release agent layer is preferably in the range of 0.3 to 2 μm and more preferably in the range of 0.5 to 1.5 μm. If the average thickness of the release agent layer 12 is less than the lower limit value, the smoothness of the outer surface 121 of the release agent layer 12 becomes insufficient. As a result, there is a fear that, when the green sheet is molded on the outer surface 121 of the release agent layer 12, the pinhole, the partial thickness variation or the like is generated in the green sheet. On the other hand, if the average thickness of the release agent layer 12 exceeds the upper limit value, a curl is easily generated in the release film 1 for producing the green sheet due to shrinkage by curing the release agent layer 12. Furthermore, the blocking is easily generated between the base material 11 and the release agent layer 12. For that reason, there is a fear that a trouble is generated in winding the release film 1 for producing the green sheet or that an electric charge amount is increased when unwinding the release film 1 for producing the green sheet.

<Back Coat Layer>

The back coat layer 13 is formed on the second surface 112 of the base material 11.

By forming the back coat layer 13 on the second surface 112, the second surface 112 having a relatively rough surface shape of the base material 11 is not in contact with the green sheet directly. For this reason, it is possible to prevent the generation of the pinhole and the partial thickness variation in the green sheet.

Furthermore, the back coat layer 13 is a layer which is formed by irradiating the active energy ray to the back-coat-layer-forming material including the active energy ray curable compound (a2) and curing the back-coat-layer-forming material. For this reason, while it is possible to easily form the back coat layer 13 having the smooth outer surface 131, it is possible to prevent the generation of the static electricity at unwinding the release film 1 for producing the green sheet.

[Active Energy Ray Curable Compound (a2)]

Examples of the active energy ray curable compound (a2) include compounds similar to the compounds described in the column of the active energy ray curable compound (a1) described above.

It is preferable that the active energy ray curable compound (a2) is the same compound as the active energy ray curable compound (a1) of the release agent layer 12. Thus, it is possible to prevent the generation of the static electricity at unwinding the release film 1 for producing the green sheet.

A solid component content (content ratio in the total solid components except a solvent) of the active energy ray curable compound (a2) in the back-coat-layer-forming material is preferably in the range of 65 to 100 mass %, more preferably in the range of 65 to 98.5 mass % and particularly preferably in the range of 71 to 96.5 mass %.

[Polyorganosiloxane (b2)]

The back-coat-layer-forming material may include the polyorganosiloxane (b2).

Examples of the polyorganosiloxane (b2) may include compounds similar to the compounds described in the column of the polyorganosiloxane (b1).

Thus, after a laminated body in which the green sheet is formed on the release agent layer 12 of the release film 1 for producing the green sheet is wound in a roll shape, when the laminated body is unwound from the roll, it is possible to suppress the green sheet, which has been in contact with the back coat layer 13, from transferring to the back coat layer 13.

A solid component content of the polyorganosiloxane (b2) in the back-coat-layer-forming material is preferably in the range of 0 to 5 mass % and more preferably in the range of 0.5 to 4 mass %.

[Photopolymerization Initiator (c2)]

In case where the ultraviolet rays are used as the active energy rays for curing the back-coat-layer-forming material, the back-coat-layer-forming material may include a photopolymerization initiator (c2).

Examples of the photopolymerization initiator (c2) may include compounds similar to the compounds described in the column of photopolymerization initiator (c1).

A solid component content of the photopolymerization initiator (c2) in the back-coat-layer-forming material is preferably in the range of 1 to 20 mass % and more preferably in the range of 3 to 15 mass %. In this case, even if the thickness of the back coat layer 13 falls with a range in which it is difficult to obtain the curability due to the oxygen inhibition, it is possible to obtain the superior curability and the superior solvent resistance.

The back-coat-layer-forming material may contain other components in addition to the aforementioned components. For instance, the back-coat-layer-forming material may contain other photopolymerization initiator, a sensitizer, an antistatic agent, a hardening agent, a reactive monomer, and so forth.

A solid component content of other components in the back-coat-layer-forming material is preferably in the range of 0 to 10 mass %.

The arithmetic average roughness Ra₃ of the outer surface 131 of the back coat layer 13 is in the range of 5 to 40 nm. It is more preferred that the arithmetic average roughness Ra₃ of the outer surface 131 of the back coat layer 13 is in the range of 10 to 30 nm. In this case, it is possible to prevent the generation of the pinhole, the partial thickness variation and the like in the green sheet. As a result, it is possible to form the high-quality green sheet. Further, it is possible to effectively suppress the winding deviation at winding the release film 1 for producing the green sheet. For that reason, there is no need to increase the winding tension. It is therefore possible to suppress a deformation of the release film 1 for producing the green sheet, which is wound around the winding core, caused by the winding tension.

The maximum projection height Rp₃ of the outer surface 131 of the back coat layer 13 is in the range of 60 to 500 nm. The maximum projection height Rp₃ of the outer surface 131 of the back coat layer 13 is more preferably in the range of 80 to 400 nm and particularly preferably is in the range of 100 to 300 nm. In this case, when the release film 1 for producing the green sheet, in which the outer surface 121 of the release agent layer 12 is highly smooth, is wound around a paper-made, plastic-made, metal-made core member or the like in the roll shape, an air is removed well. This makes it possible to effectively suppress the winding deviation. For that reason, there is no need to increase the winding tension. It is therefore possible to suppress the deformation of the release film 1 for producing the green sheet, which is wound around the winding core, caused by the winding tension. Furthermore, it is possible to prevent the generation of the blocking between the front and rear surfaces of the release film 1 for producing the green sheet wound in the roll shape. Moreover, when the release film 1 for producing the green sheet provided with the green sheet is stored in an wound state, it is possible to prevent a surface shape of the outer surface 131 of the back coat layer 13 to be closely contacted with the green sheet from being transferred to the green sheet. It is also possible to prevent the generation of the pinhole and the partial thickness variation in the green sheet. As a result, it is possible to form the high-quality green sheet.

An average thickness of the back coat layer 13 is preferably in the range of 0.01 to 2 μm and more preferably in the range of 0.05 to 1.5 μm. In case where the average thickness of the back coat layer 13 is less than the upper limit value, it is possible to suppress the curl from easily generating in the release film 1 for producing the green sheet due to the shrinkage by curing the back coat layer 13. Furthermore, it is possible to suppress the blocking from easily generating between the base 11 and the back coat layer 13 and it is possible to suppress the fear that the trouble is generated in winding the release film 1 for producing the green sheet. In case where the average thickness of the back coat layer 13 is more than the lower limit value, it is possible to suppress a fear that the electric charge amount is increased when unwinding the release film 1 for producing the green sheet.

(Method of Producing Release Film for Producing Green Sheet)

Next, description will be made on one preferred embodiment of a method of producing the release film 1 for producing the green sheet described above.

The method according to the present embodiment includes a first step for preparing the base material 11, a second step for forming the release agent layer 12 on the first surface 111 of the base material 11 and a third step for forming the back coat layer 13 on the second surface 112 of the base material 11.

The respective steps will now be described in detail.

<First Step>

First, the base material 11 is prepared.

The first surface 111 of the base material 11 can be subjected to a surface treatment using an oxidation method and the like. This makes it possible to keep superior adhesion of the base material 11 and the release agent layer 12 provided on the first surface 111 of the base material 11.

Examples of the oxidation method may include a corona discharge treatment, a plasma discharge treatment, a chromium oxidation treatment (wet-type), a flame treatment, a hot air treatment, an ozone treatment, an ultraviolet irradiation treatment and the like. These surface treatment methods are properly selected depending on the kind of the base material 11. The corona discharge treatment method is generally preferred from the aspect of the effect and operability.

<Second Step>

In the second step, the release agent layer 12 is formed on the first surface 111 of the base material 11.

Specifically, first, the coated layer is obtained by coating the release-agent-layer-forming material on the first surface 111 of the base material 11 and drying the release-agent-layer-forming material. Between the coating process and the drying process, the release-agent-layer-forming material fills the spaces of depressed parts and the slant surfaces of raised parts of the first surface 111 of the base material 11, thereby forming a smoothened coated layer.

Next, a smoothened release agent layer 12 is formed by irradiating the active energy rays to the coated layer and curing the coated layer. In case where the active energy rays are the ultraviolet rays, the irradiation amount thereof is set such that the accumulated amount of light is preferably in the range of 50 to 1000 mJ/cm² and more preferably in the range of 100 to 500 mJ/cm². In case where the active energy rays are the electron beam, the irradiation amount of the electron beam is preferably in the range of 0.1 to 50 kGy approximately.

Examples of a coating method of the release-agent-layer-forming material may include a gravure coating method, a bar coating method, a spray coating method, a spin coating method, a knife coating method, a roll coating method, a die coating method and the like.

The release-agent-layer-forming material is obtained by dissolving or dispersing such components as the active energy ray curable compound (a1) and the polyorganosiloxane (b1) capable of bonding to the active energy ray curable compound (a1) in a solvent.

Examples of the solvent may include methanol, ethanol, toluene, ethyl acetate, xylene, methyl ethyl ketone, methyl butyl ketone, isopropyl alcohol and the like.

<Third Step>

In the third step, the back coat layer 13 is formed on the second surface 112 of the base material 11.

The second surface 112 of the base material 11 can be subjected to the surface treatment using the oxidation method and the like as with the first surface 111. This makes it possible to keep the superior adhesion of the base material 11 and the back coat layer 13 provided on the second surface 112 of the base material 11.

Specifically, first, the coated layer is obtained by coating the back-coat-layer-forming material on the second surface 112 of the base material 11 and drying the back-coat-layer-forming material.

Next, the back coat layer 13 is formed by irradiating the active energy rays to the coated layer and curing the coated layer. Thus, the release film 1 for producing the green sheet is obtained. In case where the active energy rays are the ultraviolet rays, the irradiation amount thereof is set such that an accumulated amount of light is preferably in the range of 50 to 1000 mJ/cm² and more preferably in the range of 100 to 500 mJ/cm². In case where the active energy rays are the electron beam, the irradiation amount of the electron beam is preferably in the range of 0.1 to 50 kGy approximately.

Examples of a coating method of the back-coat-layer-forming material may include methods similar to the methods described in the second step.

The back-coat-layer-forming material is obtained by dissolving or dispersing such components as the active energy ray curable compound (a2) in a solvent.

Examples of the solvent may include solvents similar to the solvents described in the second step.

In the above description, the description has been made on the method in which the third step is carried out after the second step. However, the method according to the present invention is not limited to the aforementioned method. Examples of the method may include a method in which the second step is carried out after the third step, or a method in which the second step and the third step are carried out at the same time.

According to the steps described above, it is possible to easily produce the release film 1 for producing the green sheet that can be used in manufacturing the green sheet which is suppressed the generation of the pinhole and the partial thickness variation thereof.

While the present invention has been described in detail based on the preferred embodiment, the present invention is not limited to the aforementioned embodiment.

For example, in the aforementioned embodiment, the base material 11 has been described as being formed of a laminated body consisting of a single layer. However, the present invention is not limited thereto. For instance, the base material 11 may not be formed of the single layer but may be formed of the laminated body having two or more layers. In case where the base material 11 is the laminated body, for example, an outermost one of laminated layers, which adjoins the release agent layer 12, may serve as a layer that enhances adhesion of the release agent layer 12.

In case where the base material 11 is the laminated body, for example, an outermost one of laminated layers, which adjoins the back coat layer 13, may serve as a layer that enhances adhesion of the back coat layer 13.

The method of producing the release film 1 for producing the green sheet according to the present invention is not limited to the aforementioned method. If necessary, an arbitrary step may be added.

### EXAMPLES

Next, description will be made on specific examples of the release film for producing the green sheet according to the present invention.

### [1] Production of Release Film for Producing Green Sheet

### Example 1

First, a biaxially-stretched polyethyleneterephthalate film [having a thickness of 38 μm, an arithmetic average roughness Ra₁ of a first surface of 42 nm, a maximum projection height Rp₁ of the first surface of 619 nm, an arithmetic average roughness Ra₀ of a second surface of 42 nm, and a maximum projection height Rp₀ of the second surface of 619 nm] was prepared as a base material.

Next, 94 mass parts of dipentaerythritol hexaacrylate [having a solid content of 100 mass %] as an active energy ray curable compound (a1), 1 mass part of polydimethyl siloxane containing a polyether-modified acryloyl group [produced by BYK-Chemie GmbH and sold under a trade name “BYK-3500”, and having a solid content of 100 mass %] as a polyorganosiloxane (b1), and 5 mass parts of an α-aminoalkylphenone-based photopolymerization initiator [2-methyl-1-[4-(methylthio)phenyl]-2-morpholinopropane-1-one produced by BASF Corporation and sold under a trade name “IRGACURE907”, and having a solid content of 100 mass %] as a photopolymerization initiator (c1), were diluted with a mixed solvent of isopropyl alcohol and methyl ethyl ketone (having a mass ratio of 3/1). Thus, a release-agent-layer-forming material having a solid content of 20 mass % was obtained.

The release-agent-layer-forming material was coated on the first surface of the base material with a bar coater. The release-agent-layer-forming material was dried at 80° C. for one minute. And then, a release agent layer (having a thickness of 1.2 μm) was formed by irradiating ultraviolet rays to the release-agent-layer-forming material (in an accumulated amount of light of 250 mJ/cm²).

On the other hand, 94 mass parts of dipentaerythritol hexaacrylate [having a solid content of 100 mass %] as an active energy ray curable compound (a2), 1 mass part of polydimethyl siloxane containing a polyether-modified acryloyl group [produced by BYK-Chemie GmbH and sold under a trade name “BYK-3500”, and having a solid content of 100 mass %] as a polyorganosiloxane (b2), and 5 mass parts of an α-aminoalkylphenone-based photopolymerization initiator [2-methyl-1-[4-(methylthio)phenyl]-2-morpholinopropane-1-one produced by BASF Corporation and sold under a trade name “IRGACURE907”, and having a solid content of 100 mass %] as a photopolymerization initiator (c2), were diluted with a mixed solvent of isopropyl alcohol and methyl ethyl ketone (having a mass ratio of 3/1). Thus, a back-coat-layer-forming material having a solid content of 20 mass % was obtained.

The back-coat-layer-forming material was coated on the second surface of the base material with a bar coater. The back-coat-layer-forming material was dried at 80° C. for one minute. And then, a back coat layer (having a thickness of 0.57 μm) was formed by irradiating ultraviolet rays to the back-coat-layer-forming material (in an accumulated amount of light of 250 mJ/cm²). Consequently, a release film for producing a green sheet was obtained.

### Examples 2 to 4

Release films for producing a green sheet were produced in the same manner as in Example 1 except that the thickness of the back coat layer and a surface roughness of a back surface of the release film for producing the green sheet were changed as shown in Table 1.

### Example 5

A release film for producing a green sheet was produced in the same manner as in Example 1 except that the back-coat-layer-forming material in Example 1 was changed to a back-coat-layer-forming material having a solid content of 20 mass % which was obtained by diluting 95 mass parts of dipentaerythritol hexaacrylate [having the solid content of 100 mass %] as an active energy ray curable compound (a2) and 5 mass parts of an α-aminoalkylphenone-based photopolymerization initiator [2-methyl-1-[4-(methylthio)phenyl]-2-morpholinopropane-1-one produced by BASF Corporation and sold under a trade name “IRGACURE907”, and having a solid content of 100 mass %] as a photopolymerization initiator (c2) with a mixed solvent of isopropyl alcohol and methyl ethyl ketone (having a mass ratio of 3/1), and that a surface roughness of a back surface of the release film for producing the green sheet was changed as shown in Table 1.

### Example 6

A release film for producing a green sheet was produced in the same manner as in Example 1 except that the thickness of the release agent layer and the surface roughness of the release agent layer were changed as shown in Table 1.

### Example 7

A release film for producing a green sheet was produced in the same manner as in Example 1 except that the base material was changed to a biaxially-stretched polyethyleneterephthalate film [having a thickness of 31 μm, an arithmetic average roughness Ra₁ of a first surface of 29 nm, a maximum projection height Rp₁ of the first surface of 257 nm, an arithmetic average roughness Ra₀ of a second surface of 29 nm, and a maximum projection height Rp₀ of the second surface of 257 nm] and that the thicknesses of the release agent layer and the back coat layer and the surface roughnesses of the release agent layer and a back surface of the release film for producing the green sheet were changed as shown in Table 1.

### Example 8

A release film for producing a green sheet was produced in the same manner as in Example 7 except that the thicknesses of the release agent layer and the back coat layer and the surface roughness of the release agent layer were changed as shown in Table 1.

### Comparative Example 1

A release film for producing a green sheet was produced in the same manner as in Example 1 except that the back coat layer is not formed and that a surface roughness of a back surface of the release film for producing the green sheet was changed as shown in Table 1.

### Comparative Example 2

A release film for producing a green sheet was produced in the same manner as in Comparative Example 1 except that a thickness of a release agent layer and a surface roughness of a release agent layer were changed as shown in Table 1.

### Comparative Example 3

A release film for producing a green sheet was produced in the same manner as in Comparative Example 1 except that a base material was changed to a biaxially-stretched polyethyleneterephthalate film [having a thickness of 31 μm, an arithmetic average roughness Ra₁ of a first surface of 15 nm, a maximum projection height Rp₁ of the first surface of 98 nm, an arithmetic average roughness Ra₀ of a second surface of 15 nm, and a maximum projection height Rp₀ of the second surface of 98 nm] and that the thickness of the release agent layer and the surface roughnesses of the release agent layer and a back surface of the release film for producing the green sheet were changed as shown in Table 1.

### Comparative Example 4

100 mass parts of thermosetting addition reaction-type silicone [produced by Shin-Etsu Chemical Co., Ltd. and sold under a trade name “KS-847H”] was diluted with toluene, and then mixed with 2 mass parts of a platinum catalyst [produced by Shin-Etsu Chemical Co., Ltd. and sold under a trade name “CAT-PL-50T”] to prepare a coating liquid having a solid content of 5.0 mass %. The coating liquid was uniformly coated on a first surface of a base material so that a thickness thereof after drying was 1.0 μm. Next, the coating liquid was dried at 140° C. for one minute. Thus, a release agent layer was obtained. Next, a back coat layer was formed on a second surface of the base material in the same manner as in Example 6. Furthermore, a release film for producing the green sheet was produced so that thicknesses of the release agent layer and the back coat layer and surface roughnesses of the release agent layer and a back surface of the release film for producing the green sheet were set as shown in Table 1.

These results are shown in Table 1.

The thicknesses of the release agent layers and the back coat layers of the respective Examples and the respective Comparative Examples were measured with a reflection-type film thickness meter “F20” [made by Filmetrics Co, Ltd].

An arithmetic average roughness and a maximum projection height were measured in the following manner. First, a double-side tape was attached to a glass plate. Then, each of the release films for producing the green sheets obtained in the respective Examples and the respective Comparative Examples was fixed to the double-side tape such that a surface opposite to a surface to be measured was positioned at a side of the glass plate. Subsequently, the arithmetic average roughness and the maximum projection height were measured in accordance with JIS B0601-1994 using a surface roughness meter “SV3000S4” (probe type) made by Mitsutoyo Corporation.

An area occupation ratio of projections having a height of 10 nm or higher was calculated from an image obtained by using an optical interference type surface profiler [made by Veeco Instruments Inc. and sold under a trade name “WYKO-1100”]. The observation was conducted in a PSI mode and at a magnification of 50. In a surface shape image in a region of 91.2 μm×119.8 μm of the obtained image, a binarization process was performed on an image of parts having the projection height of 10 nm or higher and an image of the other parts. Next, an area ratio of a region of the parts having the projection height of 10 nm or higher and a region of the other parts was calculated. The area occupation ratio of projections having the height of 10 nm or higher was obtained from the area ratio.

TABLE 1

| | | | | Back Surface of Release Film for producing Green Sheet | | | |
|---|---|---|---|---|---|---|---|
| | | | | | | Surface Roughness of | |
| | | | | | | Back Surface | |
| | | | | | | of Release | |
| | | | | | | Film for producing | |
| | Back Coat Layer | | | | | Green Sheet | |
| | | Existence or | | | Surface Roughness- | Arthmatic | Maximum |
| | | Nonexistence | | Exiextence or | Measuring Side of Back | Average | Projection |
| | Kind of Back- | of | | Nonexistence | Surface of Release Sheet | Roughness | Height |
| | Coat-Layer- | Polyorganostioxane | Thickness | of | for | Ra | Rp |
| | Forming Material | Component | [μm] | Back Coat Layer | producing Green Sheet | [nm] | [nm] |
| Example 1 | Active Energy Ray | Existence | 0.57 | Existence | Outer Surface of | 16 | 273 |
| | Curable Type | | | | Back Coat Layer | | |
| Example 2 | Active Energy Ray | Existence | 0.39 | Existence | Outer Surface of | 23 | 314 |
| | Curable Type | | | | Back Coat Layer | | |
| Example 3 | Active Energy Ray | Existence | 0.15 | Existence | Outer Surface of | 30 | 450 |
| | Curable Type | | | | Back Coat Layer | | |
| Example 4 | Active Energy Ray | Existence | 0.88 | Existence | Outer Surface of | 7 | 95 |
| | Curable Type | | | | Back Coat Layer | | |
| Example 5 | Active Energy Ray | Nonexistence | 0.57 | Existence | Outer Surface of | 16 | 267 |
| | Curable Type | | | | Back Coat Layer | | |
| Example 6 | Active Energy Ray | Existence | 0.57 | Existence | Outer Surface of | 16 | 273 |
| | Curable Type | | | | Back Coat Layer | | |
| Example 7 | Active Energy Ray | Existence | 0.30 | Existence | Outer Surface of | 17 | 185 |
| | Curable Type | | | | Back Coat Layer | | |
| Example 8 | Active Energy Ray | Existence | 0.30 | Existence | Outer Surface of | 17 | 185 |
| | Curable Type | | | | Back Coat Layer | | |
| Comparative | — | — | — | Nonexistence | Outer Surface of Second | 42 | 619 |
| Example 1 | | | | | Surface of Base Material | | |
| Comparative | — | — | — | Nonexistence | Outer Surface of Second | 42 | 619 |
| Example 2 | | | | | Surface of Base Material | | |
| Comparative | — | — | — | Nonexistence | Outer Surface of Second | 15 | 98 |
| Example 3 | | | | | Surface of Base Material | | |
| Comparative | Active Energy Ray | Existence | 0.30 | Existence | Outer Surface of | 17 | 185 |
| Example 4 | Curable Type | | | | Back Coat Layer | | |

| | Release Agent Layer | | | | |
|---|---|---|---|---|---|
| | | | Surface Roughness of Outer Surface | | |
| | | | of Release Agent Layer | | |
| | | | Arthmatic | Maximum | Area Occupation |
| | | | Average | Projection | ratio of Projections |
| | Kind of Release- | | Roughness | Height | having Height of |
| | Agent-Layer- | Thickness | Ra₂ | Rp₂ | 10 nm or higher |
| | Forming Material | [μm] | [nm] | [nm] | [%] |
| Example 1 | Active Energy Ray | 1.2 | 4 | 38 | 5.0 |
| | Curable Type | | | | |
| Example 2 | Active Energy Ray | 1.2 | 4 | 38 | 5.0 |
| | Curable Type | | | | |
| Example 3 | Active Energy Ray | 1.2 | 4 | 38 | 5.0 |
| | Curable Type | | | | |
| Example 4 | Active Energy Ray | 1.2 | 4 | 38 | 5.0 |
| | Curable Type | | | | |
| Example 5 | Active Energy Ray | 1.2 | 4 | 38 | 5.0 |
| | Curable Type | | | | |
| Example 6 | Active Energy Ray | 3.0 | 4 | 36 | 4.5 |
| | Curable Type | | | | |
| Example 7 | Active Energy Ray | 1.2 | 3 | 15 | 1.8 |
| | Curable Type | | | | |
| Example 8 | Active Energy Ray | 0.5 | 5 | 49 | 9.7 |
| | Curable Type | | | | |
| Comparative | Active Energy Ray | 1.2 | 4 | 38 | 5.0 |
| Example 1 | Curable Type | | | | |
| Comparative | Active Energy Ray | 3.0 | 4 | 36 | 4.5 |
| Example 2 | Curable Type | | | | |
| Comparative | Active Energy Ray | 1.2 | 3 | 10 | 0.1 |
| Example 3 | Curable Type | | | | |
| Comparative | Thermosetting Type | 1.0 | 14 | 128 | 14.8 |
| Example 4 | | | | | |

### [2] Evaluation

The following evaluations were conducted with respect to the release films for producing the green sheets thus obtained.

[2.1] Curability Evaluation

The surface of the release agent layer of each of the release films for producing the green sheets obtained in the respective Examples and the respective Comparative Examples was reciprocatively polished ten times at a load of 1 kg/cm² using a waste cloth (made by Ozu Corporation and sold under a trade name “BEMCOT AP-2”) containing 3 ml of MEK. Thereafter, the surface of the release agent layer was visually observed. The curability was evaluated under the following evaluation criteria.

A: The release agent layer was not dissolved and exfoliated.

B: The release agent layer was partially dissolved.

C: The release agent layer was completely dissolved and exfoliated.

[2.2] Curl Evaluation

Each of the release films for producing the green sheets obtained in the respective Examples and the respective Comparative Examples was cut into a size of 200 mm×200 mm. Thereafter, each of the cut release films for producing the green sheets was placed on a smooth glass plate so that the release agent layer faced upward. Next, a glass plate having a size of 100 mm×100 mm was placed on the center of the release agent layer of the cut release film for producing the green sheet. Thereafter, curl heights of an edge part of the cut release film for producing the green sheet were measured. Next, a summation of the curl heights from a surface of the glass plate to the edge part of the curled release film for producing the green sheet was obtained. The summation was evaluated under the following evaluation criteria.

A: The summation was less than 50 mm.

B: The summation was 50 mm or more but less than 100 mm.

C: The summation was 100 mm or more.

[2.3] Evaluation of Blocking Property

Each of the release films for producing the green sheets obtained in the respective Examples and the respective Comparative Examples was wound in a roll shape with a width of 400 mm and a length of 5000 m. The roll of the release film for producing the green sheet was stored for 30 days at a temperature of 40° C. and at a humidity of 50% or less. Thereafter, the outward appearance of the roll of the release film for producing the green sheet was visually observed. The blocking property thereof was evaluated under the following evaluation criteria.

A: The outward appearance was not changed from the time when the release film for producing the green sheet was wound in the roll shape (Blocking was not generated).

B: In the roll of the release film for producing the green sheet, there was a region where the hue was partially different (The release film for producing the green sheet tended to suffer from blocking but was still usable).

C: The hue was different over a wide region of the roll of the release film for producing the green sheet (Blocking was generated).

In case where, like the evaluation criterion C supra, the blocking is generated due to the close contact of the front and rear surfaces of the release film for producing the green sheet and the hue is different over the wide region of the roll of the release film for producing the green sheet, it is sometimes impossible to normally unwind the release film for producing the green sheet.

[2.4] Unwinding Electric Charge Amount

Each of the release films for producing the green sheets obtained in the respective Examples and the respective Comparative Examples was wound in a roll shape with a width of 400 mm and a length of 5000 m. The roll of the release film for producing the green sheet was stored for 30 days at a temperature of 40° C. and at a humidity of 50% or less. Thereafter, an electric charge amount when the release film for producing the green sheet was unwound at a speed of 50 m/min was measured using “KSD-0103” made by KASUGA ELECTRIC WORKS LTD. The electric charge amount was measured at a region of 100 mm of the just-unwound release film for producing the green sheet every an unwinding length of 500 M.

A: The electric charge amount was −5 kV to +5 kV.

B: The electric charge amount was −10 kV to −5 kV or +5 kV to +10 kV.

C: The electric charge amount was −10 kV or less or +10 kV or more.

[2.5] Evaluation of Coatability of Slurry

135 mass parts of a mixed solvent of toluene and ethanol (having a mass ratio of 6/4) were added to 100 mass parts of barium titanate powder [BaTio₃, produced by Sakai Chemical Industrial Co., Ltd. and sold under a trade name “BT-03”], 8 mass parts of polyvinyl butyral [produced by Sekisui Chemical Co., Ltd. and sold under a trade name “S-LEC B·K BM-2”] as a binder, and 4 mass parts of dioctyl phthalate [produced by KANTO CHEMICAL CO., INC. and sold under a trade name “DIOCTYL PHTHALATE Cica GRADE 1”] as a plasticizer. A Ceramic slurry was prepared by mixing and dispersing these substances with a ball mill. A coated layer was obtained by coating the ceramic slurry, with a die coater, on the outer surface of the release agent layer of each of the release films for producing the green sheets obtained in the respective Examples and the respective Comparative Examples, such that, when dried, the green sheet had a thickness of 1 μm, a width of 250 mm and a length of 10 m. Each of the release films for producing the green sheets provided with the green sheets was obtained by drying the coated layer at 80° C. for one minute. Thereafter, each of the release films for producing the green sheets provided with the green sheets was irradiated with light of a fluorescent lamp from a side of the release film for producing the green sheet. Each of a surface of the green sheets was visually observed. The coatability of the ceramic slurry was evaluated under the following evaluation criteria.

A: No pinhole was found in the green sheet.

B: 1 to 5 pinholes were found in the green sheet.

C: 6 or more pinholes were found in the green sheet.

[2.6] Evaluation of Poor Unwinding

With regard to each of the release films for producing the green sheets obtained in the respective Examples and the respective Comparative Examples, the release film for producing the green sheet with the green sheet formed in the above item [2.5] was cut into a size of 110 mm×110 mm, and then two cut release films for producing the green sheets were prepared. Thereafter, the two release films for producing the green sheets with the green sheets were overlapped with each other so that the green sheet made contact with the back surface of the release film for producing the green sheet. Thereafter, the overlapped two release films for producing the green sheets with the green sheets were pressed with a load of 10 kg/cm² under the condition of a temperature of 23° C. Thereafter, all sides of the pressed two release films for producing the green sheets with the green sheets were cut into a size of 5 mm. And then, the green sheet and the back surface of the release film for producing the green sheet were released with each other. At this time, it was visually observed whether the green sheet transferred to the back surface of the release film for producing the green sheet.

A: The green sheet was not transferred to the back surface of the release film for producing the green sheet.

B: The green sheet was transferred to the back surface of the release film for producing the green sheet in an area of less than 50 cm².

C: The green sheet was transferred to the back surface of the release film for producing the green sheet in an area of 50 cm² or more.

[2.7] Evaluation of Releasability of Green Sheet

The green sheet formed in item [2.5] supra was released from the release film for producing the green sheet. At this time, evaluation was conducted as to whether the green sheet was normally released.

A: The green sheet was smoothly released without being broken, and the green sheet was not left on the release agent layer.

B: The green sheet was released without being broken, while somewhat lacking in smoothness, and the green sheet was not left on the release agent layer.

C: The green sheet was broken when releasing the same or the green sheet could not be released.

[2.8] Evaluation of the Number of Depressed parts 1

A coating liquid obtained by dissolving a polyvinyl butyral resin in a mixed solvent of toluene and ethanol (having a mass ratio of 6/4) was coated on the release agent layer of each of the release films for producing the green sheets obtained in the respective Examples and the respective Comparative Examples, such that, when dried, a polyvinyl butyral resin layer had a thickness of 3 μm. Thus, a coated layer was obtained. The polyvinyl butyral resin layer was formed by drying the coated layer at 80° C. for one minute. Subsequently, a polyester tape was attached to a surface of the polyvinyl butyral resin layer. Then, the release film for producing the green sheet was released from the polyvinyl butyral resin layer, and the polyvinyl butyral resin layer was transferred to the polyester tape. Thereafter, a surface of the polyvinyl butyral resin layer which was previously in contact with the release agent layer of the release film for producing the green sheet was observed using an optical interference type surface profiler [made by Veeco Instruments Inc. and sold under a trade name “WYKO-1100”]. The observation was conducted in a PSI mode and at a magnification of 50. The depressed parts having the shape of the release agent layer transferred thereto and having a depth of 150 nm or greater, which exist in a region of 91.2 μm×119.8 μm of the surface of the polyvinyl butyral resin layer, were counted. The number of the depressed parts was evaluated under the following evaluation criteria. In case where a capacitor was manufactured using the polyvinyl butyral resin layer (the green sheet) evaluated to be the criterion C infra, there was a tendency that short circuit was easily generated due to a decrease in breakdown voltage.

A: The number of the depressed parts was zero.

B: The number of the depressed parts was 1 to 5.

C: The number of the depressed parts was 6 or more.

[2.9] Evaluation of the Number of Depressed Parts 2

A coating liquid obtained by dissolving a polyvinyl butyral resin in a mixed solvent of toluene and ethanol (having a mass ratio of 6/4) was coated on a PET film having a thickness of 50 μm such that, when dried, a polyvinyl butyral resin layer has a thickness of 3 μm. Thus, a coated layer was obtained. The polyvinyl butyral resin layer was formed by drying the coated layer at 80° C. for one minute. A laminated body was obtained by attaching each of the release films for producing the green sheets obtained in the respective Examples and the respective Comparative Examples to the polyvinyl butyral resin layer such that the back coat layer of the release film for producing the green sheet made contact with the polyvinyl butyral resin layer. The laminated body was cut into a size of 100 mm×100 mm. Thereafter, the laminated body was pressed with a load of 5 kg/cm², whereby a shape of projection of the back coat layer of each of the release films for producing the green sheets was transferred to the polyvinyl butyral resin layer. Then, the release film for producing the green sheet was released from the polyvinyl butyral resin layer. The number of depressed parts having a depth of 500 nm or greater, which existed on a surface of the polyvinyl butyral resin layer previously kept in contact with the back coat layer of the release film for producing the green sheet, was counted. More specifically, the surface of the polyvinyl butyral resin layer was observed using an optical interference type surface profiler [made by Veeco Instruments Inc. and sold under a trade name “WYKO-1100”]. The observation was conducted in a PSI mode and at a magnification of 50. The depressed parts which existed in a region of 91.2 μm×119.8 μm of the surface of the polyvinyl butyral resin layer, were counted. The depressed parts had the shape of the back coat layer transferred thereto. The number of the depressed parts was evaluated under the following evaluation criteria. In case where a capacitor was manufactured using the polyvinyl butyral resin layer (the green sheet) evaluated to be the criterion C infra, there was a tendency that short circuit was easily generated due to a decrease in breakdown voltage.

A: The number of the depressed parts was zero.

B: The number of the depressed parts was 1 to 3.

C: The number of the depressed parts was 4 or more.

These results are shown in Table 2.

TABLE 2

| | | | Evaluation | Unwinding | Evaluation | | Evaluation | | |
|---|---|---|---|---|---|---|---|---|---|
| | | | of | Electric | of | Evaluation | of | Evaluation of the | Evaluation of the |
| | Curability | Curl | Blocking | Charge | Coatability | of Poor | Releasability of | Number of | Number of |
| | Evaluation | Evaluation | Property | Amount | of Slurry | Unwinding | Green Sheet | Depressed parts 1 | Depressed parts 2 |
| Example 1 | A | A | A | A | A | A | A | A | A |
| Example 2 | A | A | A | A | A | A | A | A | A |
| Example 3 | A | A | A | A | A | A | A | A | B |
| Example 4 | A | A | B | A | A | A | A | A | A |
| Example 5 | A | A | A | A | A | B | A | A | A |
| Example 6 | A | B | A | A | A | A | A | A | A |
| Example 7 | A | A | A | A | A | A | A | A | A |
| Example 8 | A | A | A | A | A | A | A | A | A |
| Comparative | A | A | A | B | A | B | A | A | C |
| Example 1 | | | | | | | | | |
| Comparative | A | C | A | B | A | B | A | A | C |
| Example 2 | | | | | | | | | |
| Comparative | A | A | B | C | A | C | A | A | A |
| Example 3 | | | | | | | | | |
| Comparative | A | A | C | C | C | A | A | C | A |
| Example 4 | | | | | | | | | |

As is apparent in Table 2, the release film for producing the green sheet according to the present invention was superior in the coatability of the slurry, the releasability of the formed green sheet and the smoothness of the front and rear surfaces of the green sheet. Further, the release film for producing the green sheet according to the present invention provided the effect of suppressing the generation of the pinhole and the partial thickness variation in the green sheet. Furthermore, the release film for producing the green sheet according to the present invention was less susceptible to blocking when wound in the roll shape. In addition, the release film for producing the green sheet according to the present invention could reduce the electric charge a mount when it was unwound from the roll shape. Moreover, the release film for producing the green sheet according to the present invention could prevent the green sheet from transferring to the back surface of the release film for producing the green sheet. In the comparative examples, however, satisfactory results were not obtained.

### INDUSTRIAL APPLICABILITY

The release film for producing the green sheet according to the present invention includes a base material having a first surface and a second surface; a release agent layer provided at a side of the first surface of the base material, wherein the release agent layer is formed by irradiating an active energy ray to a coated layer and curing the coated layer, wherein the coated layer is formed by coating a material on the side of the first surface of the base material, and wherein the material includes an active energy ray curable compound (a1) and a polyorganosiloxane (b1); and a back coat layer provided at a side of the second surface of the base material, wherein the back coat layer is formed by irradiating the active energy ray to a coated layer and curing the coated layer, wherein the coated layer is formed by coating a material on the side of the second surface of the base material, and wherein the material includes an active energy ray curable compound (a2), wherein an arithmetic average roughness Ra₂ of an outer surface of the release agent layer is 8 nm or less and a maximum projection height Rp₂ of the outer surface of the release agent layer is 50 nm or less, and wherein an arithmetic average roughness Ra₁ of an outer surface of the back coat layer is in the range of 5 to 40 nm and a maximum projection height Rp₃ of the outer surface of the back coat layer is in the range of 60 to 500 nm. According to the present invention, it is possible to suppress the generation of the pinhole and the partial thickness variation in the green sheet. Accordingly, the present invention is industrially applicable.

### EXPLANATION OF REFERENCE NUMERAL

1: release film for producing a green sheet
11: base material
111: first surface of a base material
112: second surface of a base material
12: release agent layer
121: outer surface of a release agent layer
13: back coat layer
131: outer surface of back coat layer

1. A release film for producing a green sheet, the release film comprising:
a base material having a first surface and a second surface;
a release agent layer provided at a side of the first surface of the base material, wherein the release agent layer is formed by irradiating an active energy ray to a coated layer and curing the coated layer, wherein the coated layer is formed by coating a release-agent-layer-forming material on the side of the first surface of the base material, and wherein the release-agent-layer-forming material includes an active energy ray curable compound (a1) and a polyorganosiloxane (b1); and
a back coat layer provided at a side of the second surface of the base material, wherein the back coat layer is formed by irradiating the active energy ray to a coated layer and curing the coated layer, wherein the coated layer is formed by coating a back-coat-layer-forming material on the side of the second surface of the base material, and wherein the back-coat-layer-forming material includes an active energy ray curable compound (a2),
wherein an arithmetic average roughness of an outer surface of the release agent layer is 8 nm or less and a maximum projection height of the outer surface of the release agent layer is 50 nm or less, and
wherein an arithmetic average roughness of an outer surface of the back coat layer is in the range of 5 to 40 nm and a maximum projection height of the outer surface of the back coat layer is in the range of 60 to 500 nm.

2. The release film of claim 1, wherein the back-coat-layer-forming material further includes a polyorganosiloxane (b2)

3. A release film for producing a green sheet, the release film comprising:
a base material having a first surface and a second surface;
a release agent layer provided at a side of the first surface of the base material, wherein the release agent layer is formed by irradiating an active energy ray to a coated layer and curing the coated layer, wherein the coated layer is formed by coating a release-agent-layer-forming material on the side of the first surface of the base material, and wherein the release-agent-layer-forming material includes an active energy ray curable compound (a1) and a polyorganosiloxane (b1); and
a back coat layer provided at a side of the second surface of the base material, wherein the back coat layer is formed by irradiating the active energy ray to a coated layer and curing the coated layer, wherein the coated layer is formed by coating a back-coat-layer-forming material on the side of the second surface of the base material, and wherein the back-coat-layer-forming material includes an active energy ray curable compound (a2),
wherein an arithmetic average roughness of an outer surface of the release agent layer is different than an arithmetic average roughness of an outer surface of the back coat layer.

4. The release film of claim 3, wherein a maximum projection height of the outer surface of the release agent layer is different than a maximum projection height of the outer surface of the back coat layer.

5. The release film of claim 4, wherein the maximum projection height of the outer surface of the release agent layer is less than the maximum projection height of the outer surface of the back coat layer.

6. The release film of claim 5, wherein the maximum projection height of the outer surface of the release agent layer is not greater than 50 nm and the maximum projection height of the outer surface of the back coat layer is in the range of 60 to 500 nm.

7. The release film of claim 3, wherein the arithmetic average roughness of the outer surface of the release agent layer is not greater than 8 nm and the arithmetic average roughness of the outer surface of the back coat layer is in the range of 5 to 40 nm.

8. The release film of claim 4, wherein the arithmetic average roughness of the outer surface of the release agent layer is not greater than 8 nm and the arithmetic average roughness of the outer surface of the back coat layer is in the range of 5 to 40 nm.

9. The release film of claim 5, wherein the arithmetic average roughness of the outer surface of the release agent layer is not greater than 8 nm and the arithmetic average roughness of the outer surface of the back coat layer is in the range of 5 to 40 nm.

10. The release film of claim 6, wherein the arithmetic average roughness of the outer surface of the release agent layer is not greater than 8 nm and the arithmetic average roughness of the outer surface of the back coat layer is in the range of 5 to 40 nm.

11. The release film of claim 3, wherein the back-coat-layer-forming material further includes a polyorganosiloxane (b2).

12. The release film of claim 5, wherein the back-coat-layer-forming material further includes a polyorganosiloxane (b2).
